(19) United States
(12) Patent Application Publication
(10) Pub. No.: US 2018/0299336 A1
(43) Pub. Date: Oct. 18, 2018

(54) PRESSURE SENSOR UTILIZING BRAGG GRATING WITH SINGLE MODE FIBER

(71) Applicant: FSP LLC, Crescent City, CA (US)

(72) Inventor: Marcel F Schemmann, Maria Hoop (NL)

(21) Appl. No.: 15/743,638

(22) PCT Filed: Jul. 11, 2016
(86) PCT No.: PCT/US16/41820

§ 371 Date: Jan. 10, 2018

Related U.S. Application Data
(60) Provisional application No. 62/191,372, filed on Jul. 11, 2015.

(51) Int. Cl. G01L 1/24; G01L 11/02; H01S 3/067; H01S 3/10

(52) U.S. Cl. CPC G01L 1/246; G01L 11/025; G01D 5/35316; H01S 3/10061; H01S 3/06712

(57) ABSTRACT

A pressure sensor includes a single mode fiber, a Bragg grating, and a polarization controller to generate additional polarization states from an input polarization state of light injected into the fiber. The sensor utilizes logic to detect a uni-axial pressure applied to the fiber that shifts a reflection wavelength of a first Bragg grating polarization state relative to a Bragg reflection wavelength of a second polarization state orthogonal to the first polarization state.

### CROSS-REFERENCE TO RELATED APPLICATIONS

This application claims priority and benefit to U.S. Provisional Application Ser. No. 62/191,372, titled “PRESSURE SENSOR UTILIZING BRAGG GRATING WITH SINGLE MODE FIBER”, filed on Jul. 11, 2015, and incorporated herein by reference in its entirety.

### BACKGROUND

### Field

The present disclosure related to optical pressure sensors

### Background

Fiber Bragg gratings are used for pressure sensing where the strain in the material is translated to a wavelength shift of a Bragg reflection. Polarization maintaining fibers are also used in pressure sensors including uni-axial pressure sensors where the wavelength shift of a Bragg reflection at one polarization differs from the wavelength shift in a second, orthogonal polarization. A single fiber can incorporate multiple sensors realized with Bragg gratings that reflect at different wavelengths and optionally multiple Bragg gratings reflecting at the same wavelength are incorporated in the fiber and differentiated by the “time of flight” of the reflections induced by these gratings when illuminated by an optical light pulse at the input to the fiber.

Uni-axial pressure sensors rely on the bi-refringence of glass optical fibers under uni-axial pressure. This means that the wavelength shift of Bragg reflectors incorporated in such fibers due to pressure applied differs for polarizations aligned with the pressure axis or orthogonal to the pressure axis. Regular single mode fiber is not polarization preserving, this means that light launched into the fiber in a particular polarization state does not remain in that state as it easily couples to modes in other polarization states that have nearly the same propagation constant. Index fluctuations and mechanical deformation of the fibers provide an effective coupling mechanism such that the input polarization state is typically lost within a small distance such as a few meters or less. Polarization maintaining fibers have a built-in stress in the fiber such that there are two orthogonal polarization states (typically linear) that have a significant difference in propagation constant such that light does not couple easily between modes in these two polarization states. Therefore light launched in one of the states remains in that state and fiber Bragg gratings can then be interrogated in a particular polarization state. Aligning the axis of the fiber with a pressure axis to be sensed allows the measurement of uni-axial pressure. However even when no pressure is applied the two propagation constants of the fiber differ and therefore two different Bragg reflections wavelengths (one of each orthogonal polarization) will occur where the exact wavelength difference depends on the amount of bi-refringence built into the fiber. It would be preferable to have a sensor that does not have a built in shift of the Bragg reflections and only shows a shift when uni-axial pressure is applied.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a sensor system 100 in accordance with one embodiment.

FIG. 2 illustrates a fiber Bragg grating pressure sensor 200 in accordance with one embodiment.

FIG. 3 illustrates a sensor system 300 in accordance with one embodiment.

FIG. 4 illustrates a sensor system 400 in accordance with one embodiment.

FIG. 5 illustrates sensor system 500 with forward modulation detection in accordance with one embodiment.

FIG. 6 illustrates detected reflection 600 in accordance with one embodiment.

FIG. 7 illustrates a wavelength scan 700 in accordance with one embodiment.

FIG. 8 illustrates an average power curve 800 in accordance with one embodiment.

FIG. 9 illustrates a wavelength scan 900 in accordance with one embodiment.

FIG. 10 illustrates a sensing system 1000 in accordance with one embodiment.

FIG. 11 illustrates a sensor system 1100 in accordance with one embodiment.

FIG. 12 illustrates a sensor system 1200 in accordance with one embodiment.

### DETAILED DESCRIPTION

Described herein is a system and method to incorporate multiple uni-axial pressure sensors in a single optical fiber. Single mode fiber is preferred rather than polarization maintaining fiber, resulting in a sensor system that can be read out over large distances at lower cost.

When using a single mode fiber, the polarization state at a Bragg grating is not known given an input polarization state for light launched toward the Bragg grating. However, by using a polarization controller all possible polarization states can be created given an input polarization state Pin. In case a linear polarization state Pbr is found at the Bragg grating that is in line with a pressure axis, an orthogonal input polarization state Pin_o will create a polarization state Pbr_o at the Bragg grating that is orthogonal to Pbr and thus orthogonal to the pressure axis.

A uni-axial pressure applied to the fiber will shift the Bragg reflection wavelength of polarization state Pbr (at the Bragg grating) relative to the Bragg reflection wavelength of polarization state Pbr_o. A Bragg reflector short enough to preserve a particular polarization state Pbr or Pbr_o throughout the length of the Bragg reflector even in single mode fiber may be utilized. A readout system is utilized that launches light in a polarization state Pin and an orthogonal polarization state Pin_o, for instance by switching between these two modes. Whereas Pin itself is not defined, the orthogonality between Pin and Pin_o is retained even when the input light is passed through a polarization controller and a fiber. The polarization controller is scanned through all possible polarization states such that at the Bragg grating a polarization state Pbr in line with a uni-axial pressure to be sensed is included in the scan. When the scan hits this polarization state Pbr then the wavelength of reflections of light at polarization states Pin and Pin_o exhibit a maximum mutual shift. As the polarization states are scanned, Pin may align with Pbr_o and thus implicitly Pin_o is aligned with Pbr_in; the mutual shift of the reflection wavelength is as great, but reversed in this case.

The system may utilize uni-axial pressure sensing based on determining the wavelength dependence of a fiber Bragg grating, where the reflection spectrum exhibits a wavelength shift dependent on the amount of pressure applied. This shift is greatest when an input polarization state is aligned with the axis of the pressure, and where preferably the pressure sensor is implemented with standard single mode fiber which does not require rotational alignment with the pressure axis. The pressure measurement may be performed by determining the shift of the Bragg grating reflection spectrum at a first and a second polarization state that are mutually orthogonal, and identifying the first polarization state where the mutual shift between reflection spectra of first and second polarization states are maximal (or close to maximal). The first polarization state may be modified with a polarization controller.

A polarization scan may change Pin such that all possible states Pbr are obtained in practice. However, for a given Pin, Pbr is not stable. In some cases vibrations and temperature cause polarization states to drift. Change rates due to these influences may occur in the ultrasonic range, generally faster than the input polarization scan. Even when a (expensive) fast polarization scanner is utilized, the delay in the reflection of a Bragg grating at some distance in the fiber (for instance several km) inhibits an ability to keep Pbr stable by controlling Pin, because the feedback loop is too slow. This may be compensated for in a number of ways, for instance the reflection spectrum of the Bragg grating may be monitored continually such that when Pbr and Pbr_o are “hit” there made is a snapshot of their reflection spectra that is stored. Post-processing may be applied to determine the maximum shift between all reflection spectra collected, resulting in a measurement of uni-axial pressure applied. Another technique is to monitor both orthogonal reflection spectra at the same time, which may be be accomplished by using two light sources combined with a polarization combiner preceding the polarization controller in the signal path. Each light source may be modulated at its own frequency, and these frequencies may be detected separately. Another approach is to alternatively sendout two orthogonal polarization states at a high frequency.

If Pin and Pin_o are launched alternating in rapid succession, the alternation rate may for instance be in the MHz to GHz range such that during the reflection spectrum measurement the polarization state is essentially stable. The spectrum analysis of the reflection is then performed, including a demodulation, such that momentarily a signal is obtained on the mutual shift of the reflection spectra.

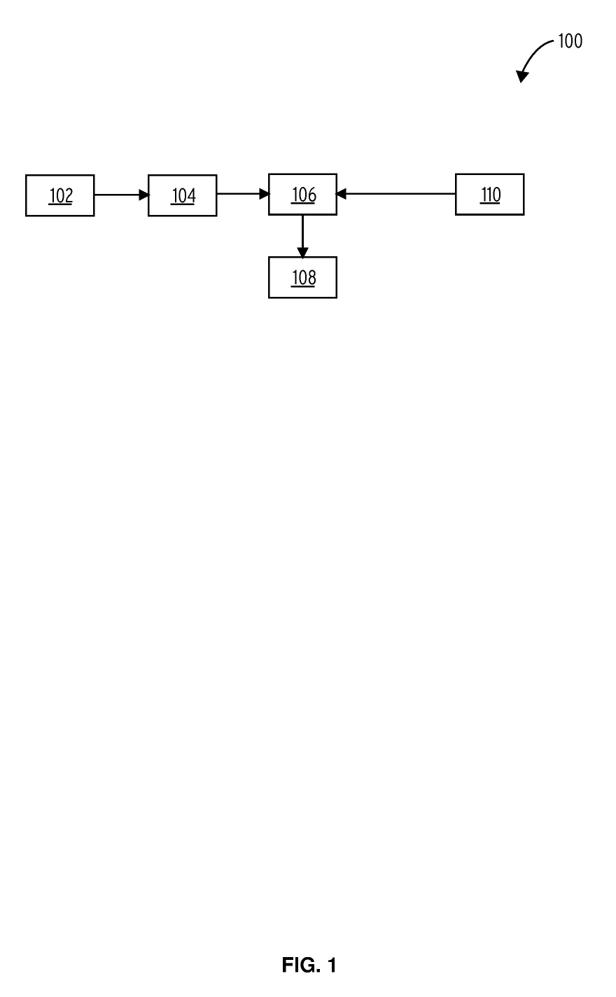

Referring to FIG. 1, an embodiment of a sensor system includes a laser 102, polarization controller 104, coupler 106, a reflection analysis system 108, fiber (arrows) and a fiber Bragg grating 110 sensor reflecting light with a polarization and wavelength dependent reflection that is at least in part provided to the reflection analysis system 108.

The reflection analysis system 108 may comprise a photodiode and logic for data processing or also include spectral filtering or optical spectrum analysis. The laser 102 may be a broadband light emitting diode where the reflection analysis system 108 carries out spectral analysis, for instance with a spectrum analyzer. The laser 102 may be a tunable laser where the wavelength of the laser 102 is a parameter in the reflection analysis system 108. In either case the reflection is determined as a function of wavelength such that the reflection spectrum of the fiber Bragg grating 110 may be determined for various polarization states.

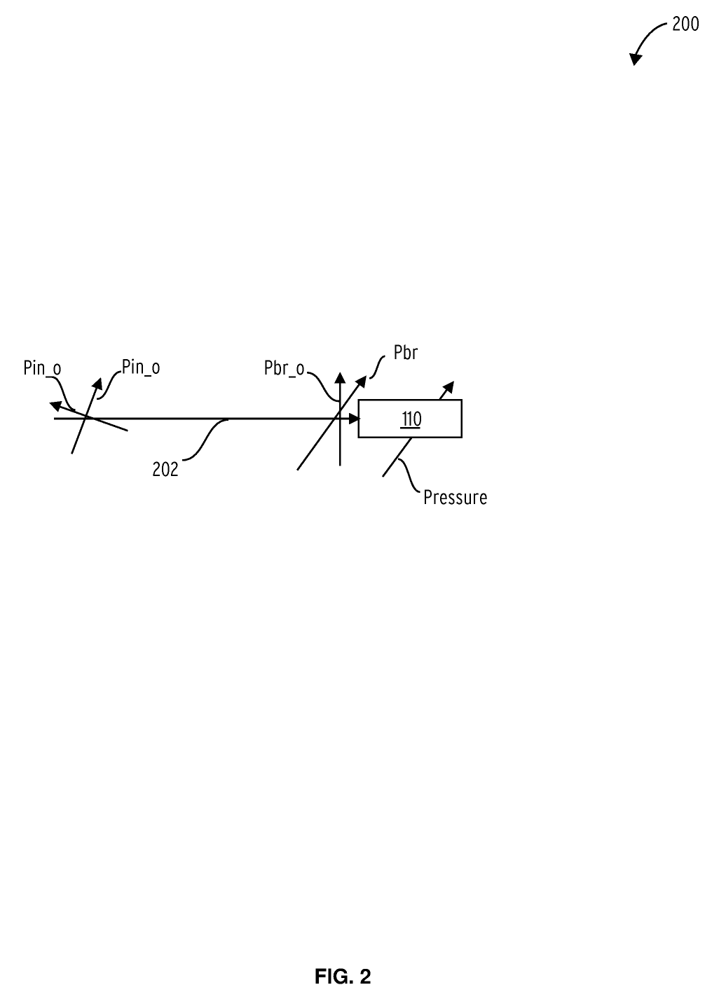

Referring to FIG. 2, the pressure on the fiber Bragg grating 110 is in-line with a polarization state Pbr at the fiber Bragg grating 110 and orthogonal to Pbr_o. Fiber input polarization states Pin and Pin_o generate light in polarization states Pbr and Pbr_o at the fiber Bragg grating 110.

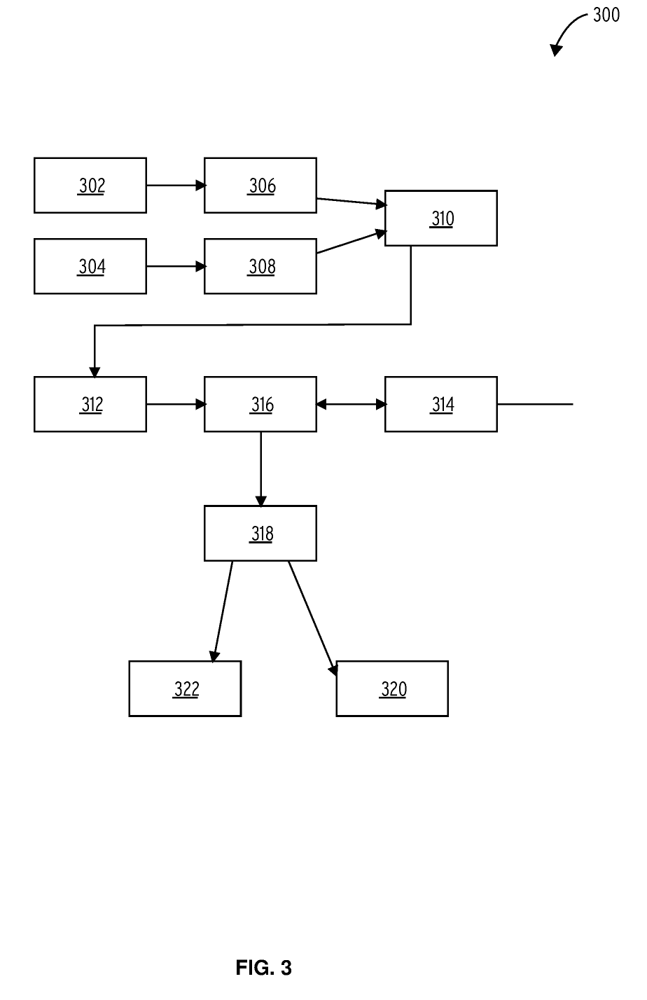

Referring to FIG. 3, a laser 306 and laser 308, each a tunable laser, are each modulated by a modulator 302 and modulator 304, respectively, at frequencies F1 and F2 respectively. (the system can scale to greater numbers of lasers and modulators). The outputs of the laser 306 and laser 308 are provided to a polarization combiner 310. The polarization combiner 310 outputs light in mutually orthogonal polarization states to a polarization controller 312 that scans for polarization states. The output of the polarization controller 312 is provided to a coupler 316 that sends the light output to (and receives light output from) a fiber Bragg grating 314.

A detector 318 receives the light output of the coupler 316. The output of detector 318 is provided to specific frequency detector 320 and specific frequency detector 322 which detect frequencies F1 and F2, respectively. (the system can scale to greater numbers of specific frequency detectors). The sensor system 300 monitors the reflection spectrum of the laser 306 and the laser 308 simultaneously; the outputs of the laser 306 and the laser 308 are launched at an orthogonal polarization state and thus arrive at the fiber Bragg grating 314 in mutually orthogonal polarization states.

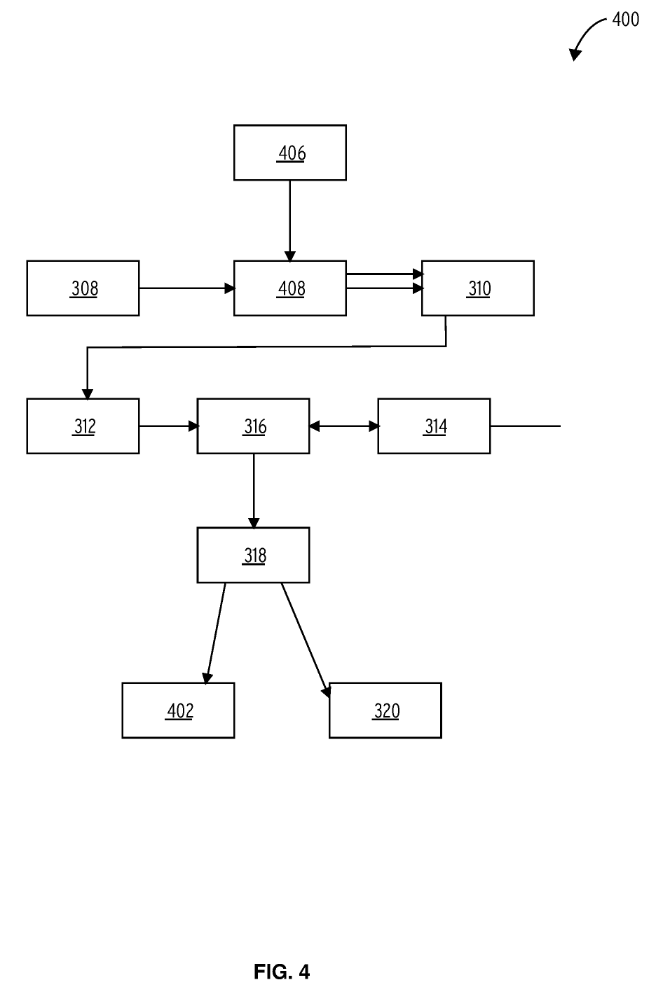

Referring to FIG. 4, one or more laser 308 input light to a dual output Mach Zehnder modulator 408, for instance fabricated with Lithium Niobate (LiNbO3), and modulated at a frequency f_mod by a frequency modulator 406. Outputs of the dual output Mach Zehnder modulator 408 are provided to the polarization combiner 310 alternately outputting light from two mutually orthogonal polarization states at a rate f_mod, followed by the polarization controller 312 to scan polarization states. a coupler 316 combines signals from the polarization controller 312 and fiber Bragg grating 314. The detector 318 is coupled to receive the output of the coupler 316, and to operate specific frequency detector 320 (e.g., for f_mod) and average power detector 402. The sensor system 400 monitors the reflection difference of two orthogonal polarization states that arrived at the fiber Bragg grating 314 in mutually orthogonal polarization states. The average reflection is also measured at the average power detector 402 such that the individual reflection curves may be reconstructed from the two orthogonal polarization states at the fiber Bragg grating 314.

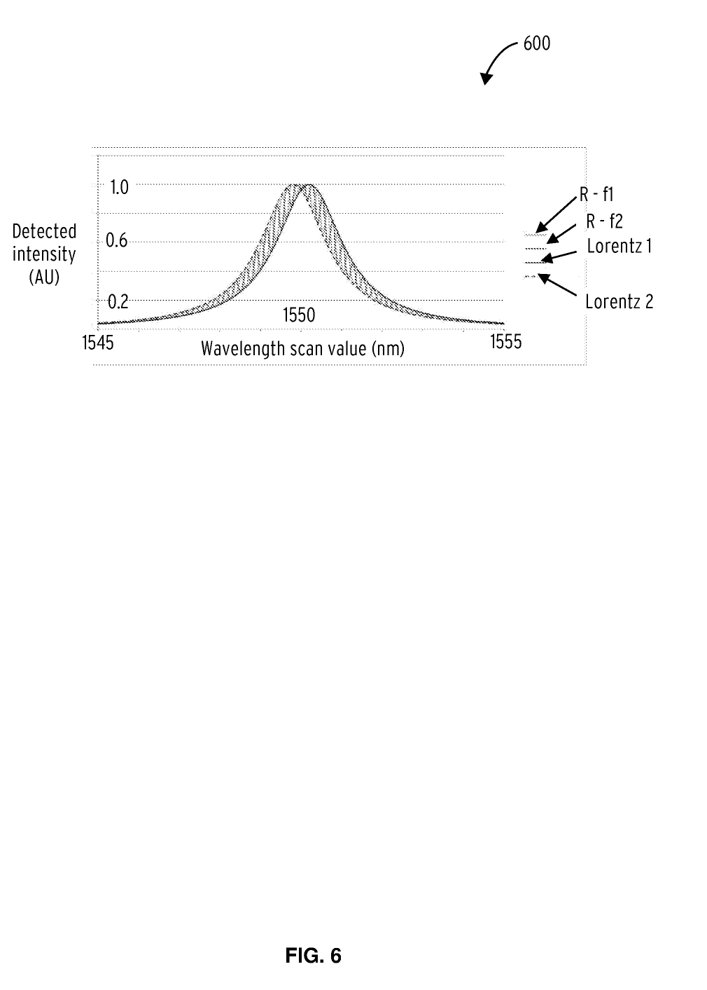

While the wavelength is scanned, the polarization state is scanned more rapidly. This is illustrated by the fast modulation in the plot of signals detected at frequencies Freq 1 and Freq 2 (e.g., two modulation frequencies) in FIG. 6. At each modulation frequency, a similar result is found, but in counter-phase. Two curves are fit (e.g., using logic applied to a machine processor circuit) to the extremes of the modulation (in this example Lorentz curves). The mutual shift of those two curves is the wavelength shift of the fiber Bragg grating 314 induced by uni-axial pressure. Knowledge that the curves of each polarization state are in counter-phase facilitates fit to the example Lorentz curves.

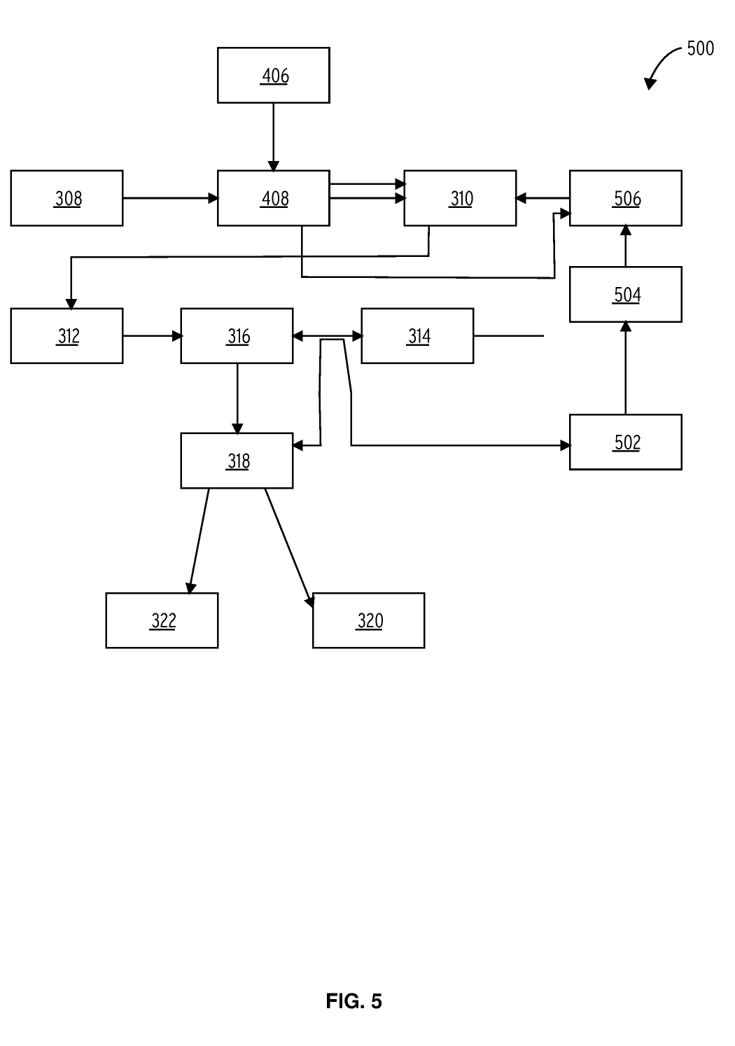

FIG. 5 illustrates a sensor system 500 utilizing forward detection of modulation and control of loss of at least one polarization state to elimination modulation of forward power. The sensor system 500 shares components with the sensor system 400, but additionally includes forward modulation detector 502, processor 504, and voltage controlled amplifier 506 to implement forward modulation detection.

In one embodiment the total amount of light launched into the fiber is held constant, optionally by monitoring the amount of launched light and controlling the loss of one of the polarization axes, Pin or Pin_o. The wavelength(s) of the one or more laser 308 applied to interrogate the fiber Bragg grating 314 is scanned to determine the wavelength dependence of their reflection spectra.

When no uni-axial pressure is applied the reflected light of Pin and Pin_o can be detected with uni-axial pressure. There is a modulation that is largest when the polarization state aligns with Pbr or Pbr_o. The sign of the modulation changes depending on whether Pbr or Pbr_o is achieved. Tracking the phase of the detected modulation is thus of value.

If the sensor system 500 has polarization dependent loss, then the light launched into the fiber has a constant power irrespective of whether Pin or Pin_o was launched. This does not guarantee that a reflection of these two polarization states would be equal and there would be a modulation detected in the reflection even with equal reflectivity for Pbr and Pbr_o (e.g., with no pressure applied). This modulation will be present at any wavelength, even when the reflectivity of the Bragg gratings is constant, which will occur at a particular wavelength. In this manner an amount of polarization dependent loss may be detected and corrected for.

In some embodiments, a voltage controlled amplifier 506 (e.g., a VCA, also referred to as a voltage controlled amplifier) may receive the output of a Mach Zehnder modulator (e.g., the dual output Mach Zehnder modulator 408). An output of the voltage controlled amplifier 506 may be provided to the polarization combiner 310 along with an output of the dual output Mach Zehnder modulator 408. A processor 504 may be employed to control the output of the voltage controlled amplifier 506 as described previously to control loss of polarization state. A forward modulation detector 502 may be provided with an output of the coupler 316. In this manner, a sensor system 500 with forward detection of modulation and control of loss of at least one polarization state to eliminate modulation of forward power may be enabled.

Radio frequency (RF) modulation may also be used for Pin and Pin_o to facilitate independent detection of Pin and Pin_o on a single detector, by modulating Pin and Pin_o at different frequencies. Each frequency may be demodulated separately and thus result in the reflections for Pin and Pin_o independently.

Modulation of the laser 308 may be used to sweep the wavelength, or a phase modulator may be applied for additional modulation and generation of cross-modulation products to facilitate detection. With a white light source or broadband source, reflections may be generated at multiple wavelengths simultaneously. Mixing of these reflections may result in a direct RF signal frequency to detect. In any of these applications, the polarization controller 312 may be applied to scan through polarization states into a fiber, and the Bragg grating reflectivity at mutually orthogonal polarization states determined. The wavelength dependence of the reflectivity is determined, and it is determined what the maximum mutual shift of those reflection spectra is while the polarization state is scanned.

While the polarization state is scanned, the mutual shift of the reflection spectra is not maximized. However the scan is rapid enough that during a wavelength scan the mutual shift is maximized sufficiently to reconstruct the minimum and maximum reflection spectra.

Referring to FIG. 6, a detected reflection 600 during a wavelength scan is illustrated. While the wavelength is scanned the polarization state is scanned more rapidly. This is illustrated with fast modulation of signals detected at Frequency 1 (f1) and Frequency 2 (f2). At each modulation frequency a similar result is achieved, but in counterphase. Two curves are fit to the extremes of the modulation (in FIG. 6, Lorentz curves). The frequency shift between the curves is the wavelength shift of the fiber Bragg grating induced by unilateral pressure.

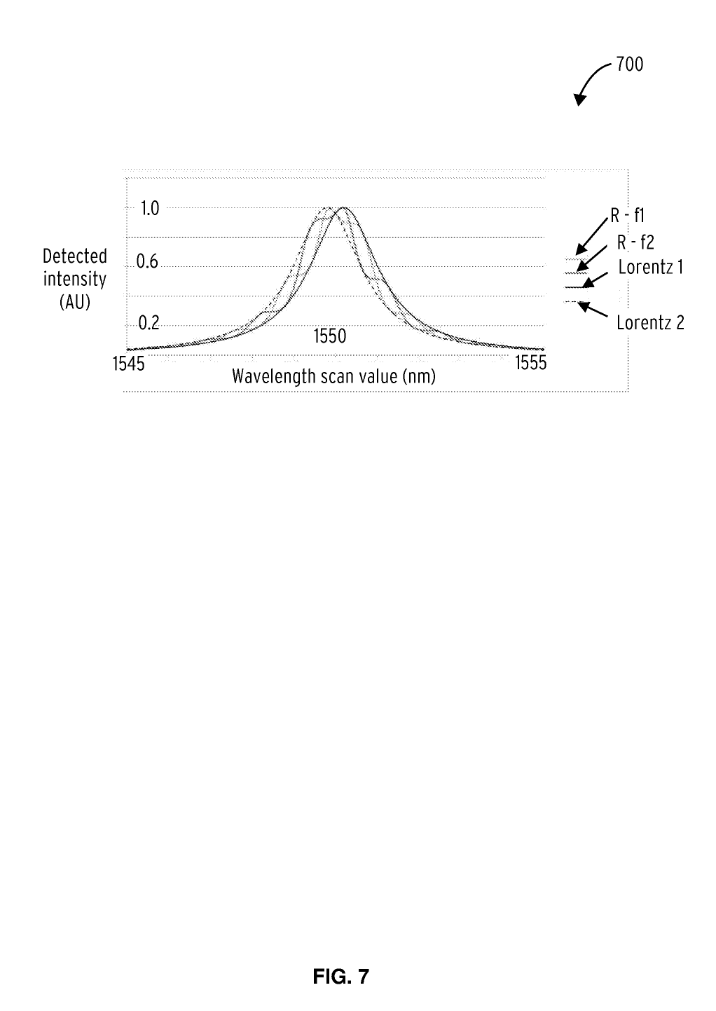

FIG. 7 illustrates a situation in which the polarization modulation is not fast enough to ensure hitting the extremes of the two curves rapidly enough to construct the fits.

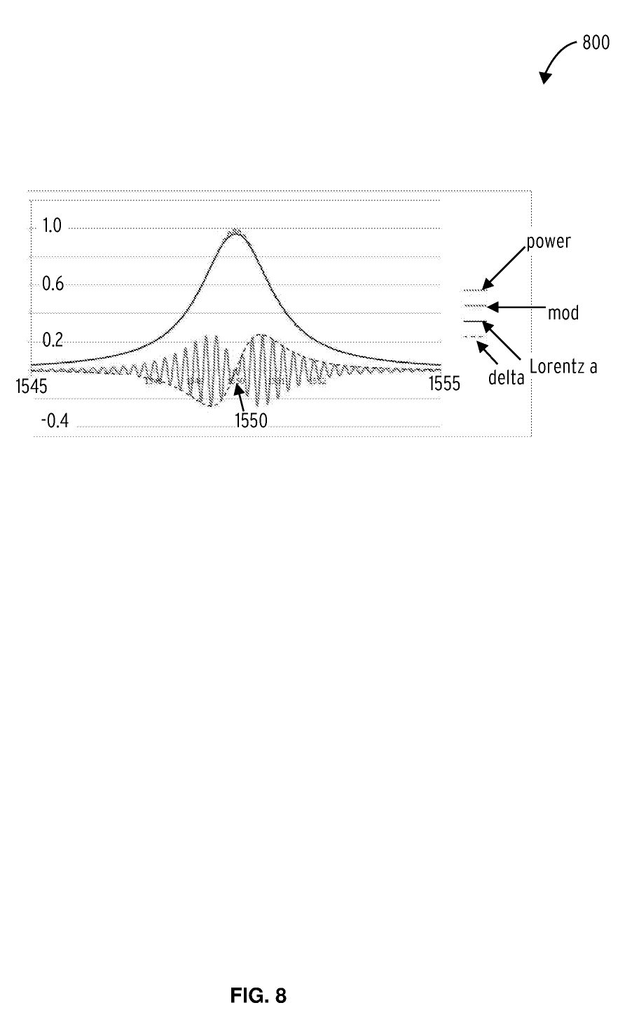

FIG. 8 illustrates an average power curve 800 showing the average power and magnitude of a modulation signal f_mod for a Mach Zehnder modulator modulated at f_mod.

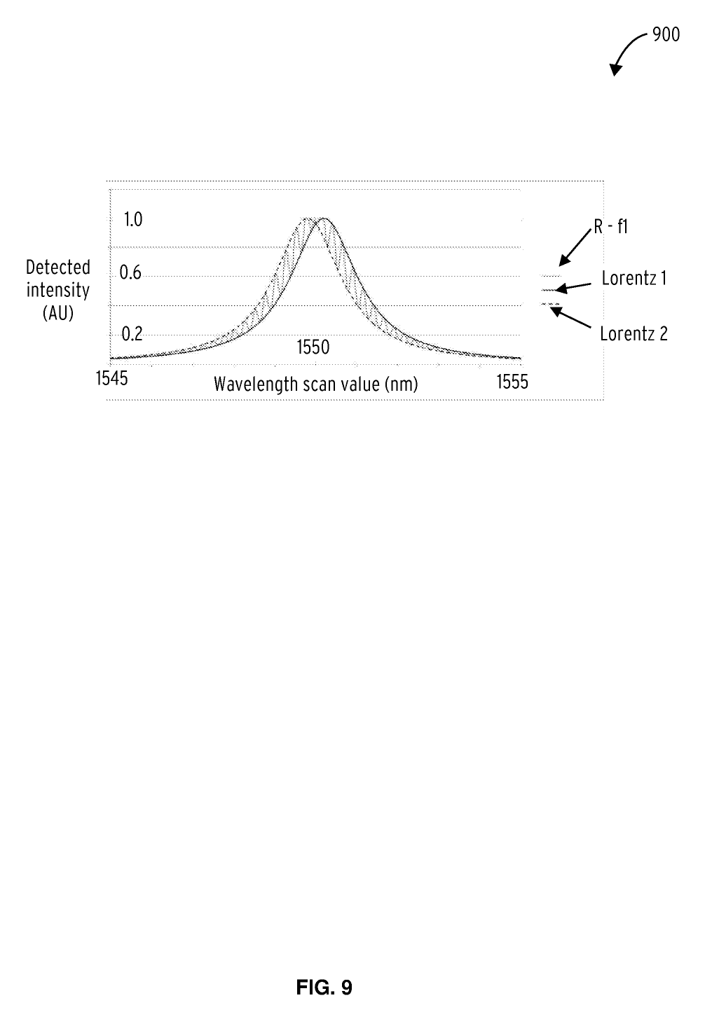

FIG. 9 illustrates a wavelength scan 900 for a varying launched polarization state and scanning the wavelength slowly enough to reconstruct the two reflection curves.

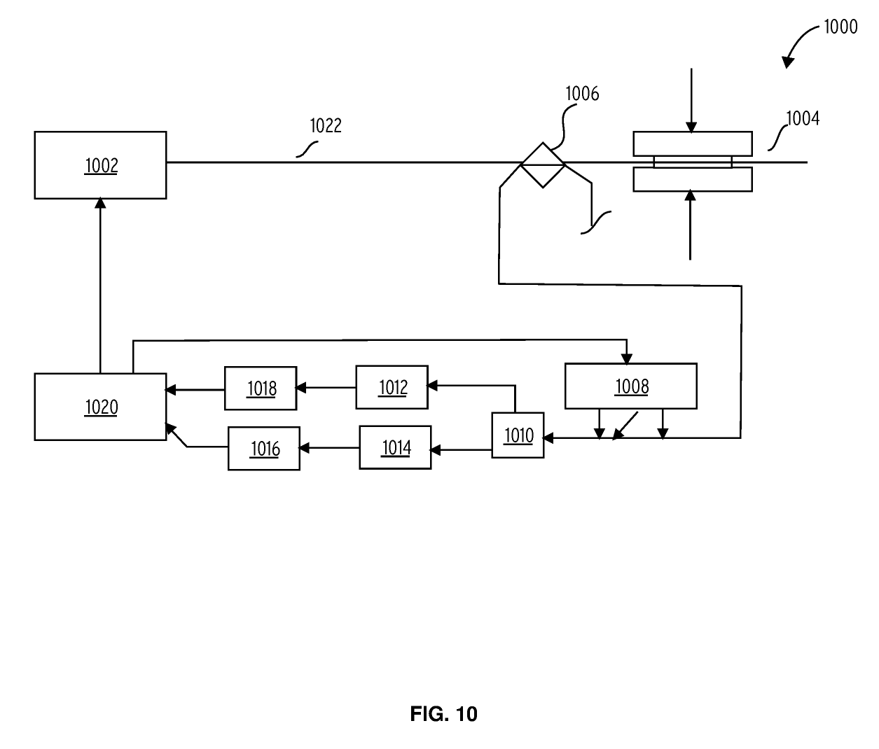

Referring to FIG. 10, the sensing system 1000 utilize polarization separation at the detection side.

A polarization-scrambled, or de-polarized, source light may be sent through an optical fiber 1022 from a tunable light source 1002 to a fiber Bragg grating 1004 under uni-axial stress due to a force applied. The reflected light travels back and through a coupler 1006 and a fraction thereof is directed to a polarization controller 1008. The polarization controller 1008 ensures that the light arriving at the preceding beam splitter 1010 is manipulated such that for an incoming polarization state all outgoing polarization states are covered. Whereas the polarization state is thus “scrambled” the mutual orthogonality of certain incoming polarization states is maintained. Such polarization states originating in the fiber Bragg grating 1004 due to reflections of light aligned with the pressure axis and orthogonal to the pressure axis. The light is separated by a polarization beam splitter 1010 and directed to two detectors (detector 1012 and detector 1014) each detecting the light of two mutually orthogonal polarization states. When the polarization controller 1008 manipulates the incoming light such that the light aligned with the pressure axis of the fiber Bragg grating 1004 aligns with one of the axis of the polarization beam splitter 1010 then this light is passed to the detector 1012. Implicitly at that point the detector 1014 will receive light from the fiber Bragg grating 1004 reflection aligned with an axis orthogonal to the pressure axis of the fiber Bragg grating 1004.

The output of the detector 1012 and the detector 1014 are digitized by analog to digital converter 1018 and analog to digital converter 1016 respectively, and the digitized values provided to a digital signal processor 1020 which provides a wavelength adjustment to the tunable light source 1002.

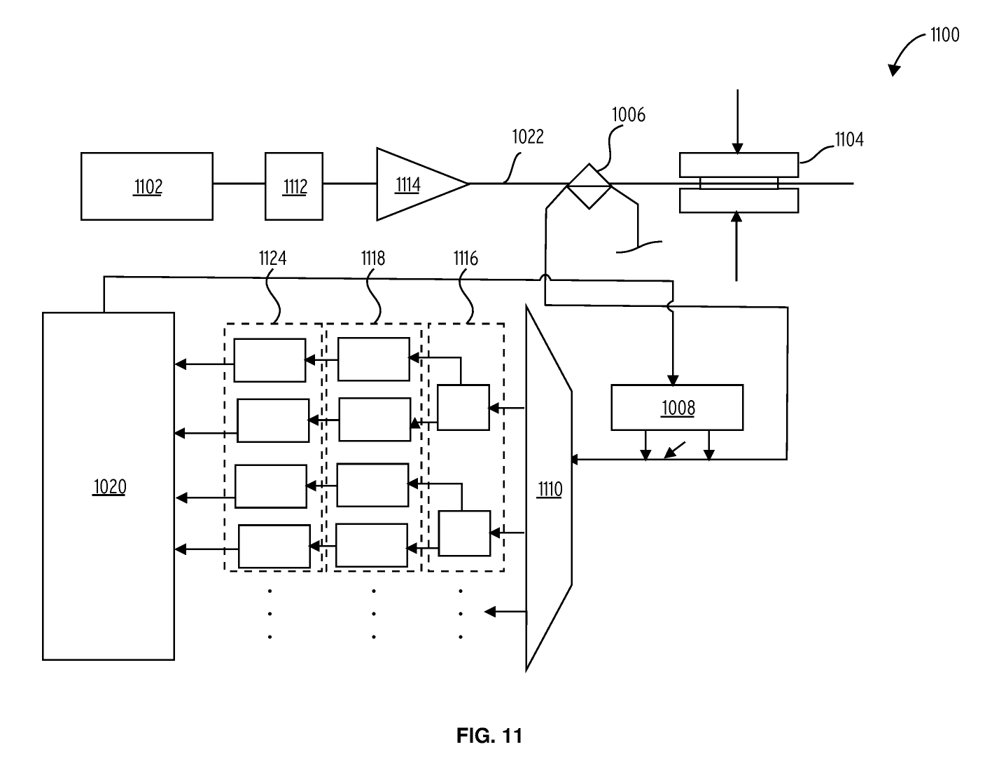

Referring to FIG. 11, a sensor system 1100 can be made to use a multi-wavelength source, for example a broadband light source 1102, a tunable filter 1112 such as a scanning Fabry Perot (FP) interferometer, and optionally an optical amplifier 1114 such as an Erbium Doped Fiber Amplifier (EDFA). Such a series of devices can produce a de-polarized output at a comb of wavelengths. The tunable filter 1112 can be designed such that the peak width of the transmission at each of these wavelengths is narrow, such as 25-50 pm, narrow enough to resolve the peak width of the fiber Bragg grating 1004 reflection peaks (□100 pm). Although one fiber Bragg grating 1004 is illustrated, in practice the sensor system 1100 would include multiple fiber Bragg gratings.

The peaks move in unison as the tunable filter 1112 is scanned such that if the fiber Bragg grating 1004 reflection peaks are designed to be on a similar comb then all fiber Bragg gratings are scanned at the same time. At the detection side the wavelengths need to be separated. This can be done with a demultiplexer 1110, for example Dense Wavelength Division de-Multiplexer (DWDM). Such DWDM devices can be used from the telecommunication area where they are widely deployed. Frequency band spacing such as 100 GHz (800 pm) or 200 GHz (1600 pm) are readily available with a pass-band on the order of ½ the spacing. An example of such a system is shown below.

FIG. 11 thus illustrates a multi-wavelength source illuminating multiple fiber Bragg gratings in device under test each reflecting at their own wavelength and separation of these reflections with a DWDM de-multiplexer onto separate detectors each receiving one of two polarization states of light at the port of the de-multiplexer. The system may utilize multiple (N) splitters 1116, detectors 1118, and analog to digital converters 1124 to supply the digital signal processor 1020 with the digitized reflections.

The output ports of the demultiplexer 1110 are each connected to one of the splitters 1116 each followed by one of the detectors 1118. This way each separate fiber Bragg grating reflection peak can be monitored simultaneously. Subsequent digitizing by one of the analog to digital converters 1124 and processing by the digital signal processor 1020 provides the sensor readout. Note that only one multi-wavelength source and one polarization controller are needed.

The number of polarization splitters 1116 can be reduced to one by placing the polarization beam splitter directly behind the polarization controller 1008, in which case however two of the demultiplexer 1110 with detectors would be needed. It is further possible to only use one output of the splitters 1116, that is use it as a polarizer. This is because the polarization controller 1008 can ensure that both light from the fiber Bragg grating reflection in the axis aligned with the pressure and from the orthogonal axis will at one time pass through the polarizer. Subsequent processing by the digital signal processor 1020 will permit reconstruction of the reflections of these axis from analysis of the reflection measurements that include on axis and intermediate polarization state results (see also previous figures).

The demultiplexer 1110 can also serve another purpose. Weak wavelength independent reflections are always present in the sensor system 1100, so the detectors 1118 will be able to measure a profile of this background while the tunable filter 1112 is scanning. As a result the wavelength comb overlap with the demultiplexer 1110 can be determined and this can serve as a wavelength reference (since the tunable filter 1112 has no absolute reference, only an accurate wavelength spacing between transmission peaks in the comb).

The tunable filter 1112 is typically a Piezo driven device, and the receive side polarization controller 1008 is also typically a Piezo driven device. In order to ensure that all polarization states are probed the tunable filter 1112 would have to scan slowly while the polarization controller 1008 is probing all states and the overall readout rate of the sensor system 1100 would be limited. In case a faster readout rate is needed then a fast polarization controller 1008 (LiNbO3 based) should be used, this will come at a higher cost (few k$) but will allow modulation rates above 1 MHz to cover all polarization states within 1 microsecond. With a tunable filter 1112 scanning rate up to 8 kHz this means that the system readout rate for all fiber Bragg gratings in the sensor could be around 8 kHz.

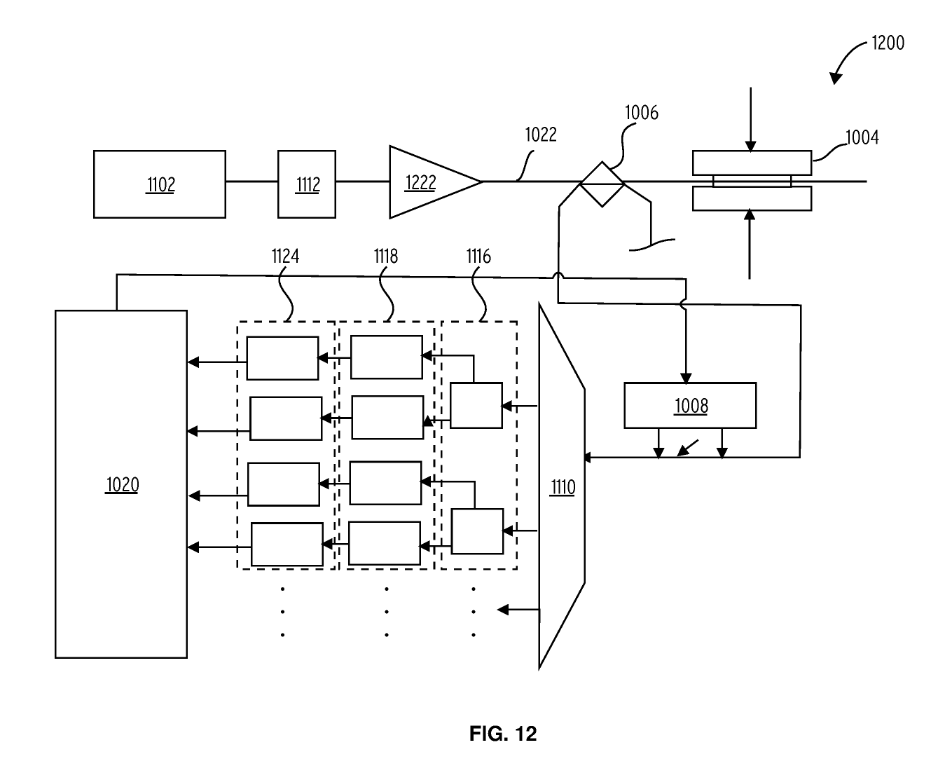

FIG. 12 illustrates a sensor system 1200 with a modulated wavelength source for time resolved detection of fiber Bragg grating reflections.

With tunable laser sources combined with modulators, higher scan rates may be achieved albeit at a high cost if many sensors are to be read out at the same time. Another goal can be to read out multiple strings of sensors cascaded along a fiber length. In order to achieve this, the readout of such sensors can be timed for the roundtrip time of light generated at the source and reflected by fiber Bragg sensors to arrive back at the detectors. Considering a light speed of 20 cm/nsec in fiber and a typical size of a multi-wavelength sensor array of 20 cm or more and assuming a separation of 1 meter or more between sensor array locations, the requirements for such an arrangement can be estimated. Readout of one such sensor array would typically take 2 nsec (roundtrip time) beyond the pulse length of the source (assuming a pulsed source is used, other arrangements are possible with modulated sources).

The separation between signals from different sensor arrays can then be expected to be on the order of 10 nsec. For a sensor array located at long distance away from the source, for instance 10 km, the roundtrip time for light emanating from the source to arrive back at the sensor array is considerable; on the order of 100 usec. This would imply that in order to differentiate between such sensor arrays, the source can send pulses not wider than 10 nsec at a rate not faster than 10 kHz. However if it is known that all sensor arrays are located within, for instance, one km that rate increases to 100 kHz. Since in addition the wavelength needs to be swept and all polarization states covered, the overall measurement rate could be low. This can in part be resolved by modulating the course, for instance chirping the frequency or stepping through a known pattern of frequencies. The receiver can then detect those frequencies in the overlapping responses from different sections on the fiber Bragg grating and continually operate the source.

There will be a limitation on the attainable modulation rate depending on the source type, for instance an LED is much slower than a laser, allowing modulation up to the 10's of MHz range (barely enough to obtain 10 ns of time resolution) to greater than 1 GHz range respectively. An Erbium Doped Fiber Amplifier ASE source will permit only modulation up to the low kHz range. A semiconductor optical amplifier on the other hand is usually not perfectly de-polarized but can permit modulation up to several 100 MHz. Use of an external modulator can permit modulation to 10 GHz and above but usually such modulators are wavelength dependent and polarization dependent such that they are more difficult to use with a comb of de-polarized wavelengths.

Semiconductor Electro Absorption Modulators (EAM) is an option with the ability to modulate a wide band of wavelengths at very high speed (>10 GHz) with only a weak wavelength dependence and a weak polarization dependence.

The figure below illustrates as system with a semiconductor optical amplifier 1222 used as a fast optical switch and optionally also as an amplifier to generate a multi-wavelength signal modulated at a high rate (up to 500 MHz approximately) with varying frequency to be able to deduce a time resolved reflection spectrum at the detectors.

References to “one embodiment” or “an embodiment” do not necessarily refer to the same embodiment, although they may. Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively, unless expressly limited to a single one or multiple ones. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list, unless expressly limited to one or the other. “Logic” refers to machine memory circuits, non transitory machine readable media, and/or circuitry which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter). Those skilled in the art will appreciate that logic may be distributed throughout one or more devices, and/or may be comprised of combinations memory, media, processing circuits and controllers, other circuits, and so on. Therefore, in the interest of clarity and correctness logic may not always be distinctly illustrated in drawings of devices and systems, although it is inherently present therein. The techniques and procedures described herein may be implemented via logic distributed in one or more computing devices. The particular distribution and choice of logic will vary according to implementation. Those having skill in the art will appreciate that there are various logic implementations by which processes and/or systems described herein can be effected (e.g., hardware, software, and/or firmware), and that the preferred vehicle will vary with the context in which the processes are deployed. “Software” refers to logic that may be readily readapted to different purposes (e.g. read/write volatile or nonvolatile memory or media). “Firmware” refers to logic embodied as read-only memories and/or media. Hardware refers to logic embodied as analog and/or digital circuits. If an implementer determines that speed and accuracy are paramount, the implementer may opt for a hardware and/or firmware vehicle; alternatively, if flexibility is paramount, the implementer may opt for a solely software implementation; or, yet again alternatively, the implementer may opt for some combination of hardware, software, and/or firmware. Hence, there are several possible vehicles by which the processes described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations may involve optically-oriented hardware, software, and or firmware. The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood as notorious by those within the art that each function and/or operation within such block diagrams, flowcharts, or examples can be implemented, individually and/or collectively, by a wide range of hardware, software, firmware, or virtually any combination thereof. Several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in standard integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and/or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, flash drives, SD cards, solid state fixed or removable storage, and computer memory. In a general sense, those skilled in the art will recognize that the various aspects described herein which can be implemented, individually and/or collectively, by a wide range of hardware, software, firmware, or any combination thereof can be viewed as being composed of various types of “circuitry.” Consequently, as used herein “circuitry” includes, but is not limited to, electrical circuitry having at least one discrete electrical circuit, electrical circuitry having at least one integrated circuit, electrical circuitry having at least one application specific integrated circuit, circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), circuitry forming a memory device (e.g., forms of random access memory), and/or circuitry forming a communications device (e.g., a modem, communications switch, or optical-electrical equipment). Those skilled in the art will recognize that it is common within the art to describe devices and/or processes in the fashion set forth herein, and thereafter use standard engineering practices to integrate such described devices and/or processes into larger systems. That is, at least a portion of the devices and/or processes described herein can be integrated into a network processing system via a reasonable amount of experimentation.

What is claimed is:

1. A pressure sensor comprising:
a single mode fiber;
a Bragg grating;
a polarization controller to generate additional polarization states from an input polarization state of light injected into the fiber; and
logic to detect a uni-axial pressure applied to the fiber that shifts a reflection wavelength of a first Bragg grating polarization state relative to a Bragg reflection wavelength of a second polarization state orthogonal to the first polarization state.
